(19) United States
(12) Patent Application Publication
(10) Pub. No.: US 2020/0278488 A1
(43) Pub. Date: Sep. 3, 2020

(54) ILLUMINATION DEVICE AND DISPLAY DEVICE

(71) Applicant: SHARP KABUSHIKI KAISHA, Osaka (JP)

(72) Inventor: HIDETAKA TERAZAWA, Osaka (JP)

(21) Appl. No.: 16/802,122

(22) Filed: Feb. 26, 2020

Related U.S. Application Data
(60) Provisional application No. 62/812,429, filed on Mar. 1, 2019.

(51) Int. Cl. F21V 8/00

(52) U.S. Cl. CPC G02B 6/0061; G02B 6/0068; G02B 6/0055; G02B 6/0076

(57) ABSTRACT

An illumination device includes a light guide plate to guide light that is provided with a cutout portion with a portion partially cut out, a plate surface of the light guide plate is provided with an auxiliary light guide plate extending from a light incident surface to a region between the cutout portion and a counter light incident surface, an auxiliary light guide plate-side light incident surface, among end faces of the auxiliary light guide plate, disposed on the light incident surface side is provided with an auxiliary light source, and a region, of the auxiliary light guide plate, overlapping the region of the light guide plate between the cutout portion and the counter light incident surface is a light exit section configured to output light from the auxiliary light source toward the region of the light guide plate between the cutout portion and the counter light incident surface.

### TECHNICAL FIELD

The technique disclosed herein relates to an illumination device and a display device including a light guide plate provided with a cutout portion such as a hole and a recessed portion.

### BACKGROUND ART

In recent years, liquid crystal display devices including liquid crystal panels have been utilized as display devices for electronic devices such as information terminals and instruments provided in vehicles such as automobiles and the like. Since the liquid crystal panel does not emit light itself, external light needs to be utilized to display an image. Thus, this type of display device includes, in addition to the liquid crystal panel, an illumination device (so-called backlight device) for supplying light to the liquid crystal panel. The backlight device is disposed on a back face side of the liquid crystal panel, and is configured to irradiate the back face of the liquid crystal panel with light spread in a planar shape.

As the backlight device, for example, as disclosed in PTL1, an edge light type (or side light type) is known that is provided with a light guide plate made from a transparent plate-shaped member and a light source (for example, LED) disposed to face an end face of the light guide plate. Light emitted from the light source of the backlight device is incident on the light guide plate from the end face of the light guide plate (hereinafter, referred to as a light incident surface) facing the light source. Then, the light propagates through the light guide plate, and is emitted from a front side plate surface (light exit surface) as a planar light.

### CITATION LIST

### Patent Literature

PTL1: JP 2013-149559A

### SUMMARY OF INVENTION

### Technical Problem

However, in an edge light type backlight device as disclosed in PTL1, a light guide plate configured to include, for example, a portion cut out such as a hole or a recessed portion (referred to as a cutout portion) has a problem that a light incident on the light guide plate from a light incident surface and traveling linearly toward a counter light incident surface opposite to the light incident surface is blocked on a path of light by the cutout portion, and therefore, brightness of a region on a counter light incident surface side is reduced than brightness of the cutout portion to generate a brightness unevenness.

In order to solve such a brightness unevenness, a configuration is conceivable in which the light source is provided also on the counter light incident surface side, but such a configuration adds complexity in configuration due to the arrangement of light source, and thus increases a size and cost of the backlight device.

The technique disclosed herein is achieved based on the above-described circumstances, and an object of the present invention is to provide an illumination device and a display device in which brightness unevenness is suppressed even when the light guide plate is provided with a cutout portion.

### Solution to Problem

(1) An embodiment of the present invention is an illumination device including: a light source; and a light guide plate configured to guide light from the light source, wherein the light guide plate includes a light incident surface on which the light from the light source is incident, a counter light incident surface opposite to the light incident surface, a light exit surface that is one of a pair of plate surfaces and outputs the light, and a counter light exit surface opposite to the light exit surface, and is provided with a cutout portion with a portion partially cut out, at least one of the pair of plate surfaces of the light guide plate is provided with an auxiliary light guide plate, the auxiliary light guide plate being configured with a plate-shaped member extending from the light incident surface to a region between the cutout portion and the counter light incident surface, an auxiliary light guide plate-side light incident surface, among end faces of the auxiliary light guide plate, disposed on the light incident surface side is provided with an auxiliary light source, the auxiliary light source being configured to emit light toward the auxiliary light guide plate-side light incident surface, and a region, of the auxiliary light guide plate, overlapping the region of the light guide plate between the cutout portion and the counter light incident surface is a light exit section, the light exit section being configured to output light from the auxiliary light source toward the region of the light guide plate between the cutout portion and the counter light incident surface.

(2) An embodiment of the present invention is the illumination device according to the configuration in (1) described above, wherein the auxiliary light guide plate is disposed to overlap the counter light exit surface of the light guide plate.

(3) An embodiment of the present invention is the illumination device according to the configuration in (1) or (2) described above, wherein the light incident surface of the light guide plate and the auxiliary light guide plate-side light incident surface of the auxiliary light guide plate are disposed to be overlapped with each other.

(4) An embodiment of the present invention is the illumination device according to the configuration in any one of (1) to (3) described above, wherein the auxiliary light guide plate is disposed to entirely overlap the light guide plate.

(5) An embodiment of the present invention is the illumination device according to the configuration in any one of (1) to (4) described above, wherein the cutout portion is a through-hole penetrating the light guide plate.

(6) An embodiment of the present invention is the illumination device according to the configuration in (5) described above, wherein the auxiliary light guide plate is formed into a U-shape including a pair of linear portions and a bent portion, the pair of linear portions extending from the light incident surface to a lateral side portions of the through-hole, and the bent portion being curved or bent to wrap around inward the through-hole continuously from the linear portions.

(7) An embodiment of the present invention is the illumination device according to the configuration in (6) described above, wherein a reflection sheet that reflects light is provided on an end face on an outer peripheral side of the bent portion.

(8) An embodiment of the present invention is the illumination device according to the configuration in any one of (1) to (4) described above, wherein the cutout portion is a recessed portion recessed concavely from a side edge of the light guide plate.

(9) An embodiment of the present invention is a display device including the illumination device according to any one of (1) to (8) described above, and a display panel configured to perform display by using light from the illumination device.

(10) An embodiment of the present invention is the display device according to the configuration in (9) described above, wherein the display panel includes a panel cutout portion cut out along the cutout portion at a position corresponding to the cutout portion.

### Advantageous Effects of Invention

According to the technique disclosed herein, the illumination device and the display device can be achieved in which brightness unevenness is suppressed even in a case that the light guide plate is provided with a cutout portion such as a hole and a recessed portion.

### BRIEF DESCRIPTION OF DRAWINGS

FIG. 1 is an exploded perspective view illustrating a liquid crystal display device according to a first embodiment.

FIG. 2 is a back view of a light guide plate and an LED.

FIG. 3 is a perspective view of a main portion of a back face side of a backlight device.

FIG. 4 is a back view of the main portion of the backlight device.

FIG. 5 is a back view of an auxiliary light guide plate and an auxiliary LED.

FIG. 6 is a cross-sectional view taken along a line A-A of FIG. 4.

FIG. 7 is a perspective view of a main portion of a back face side of a backlight device with a reflection sheet being omitted according to a second embodiment.

FIG. 8 is a back view of the main portion of the backlight device with the reflection sheet being omitted.

FIG. 9 is a cross-sectional view of a light guide plate, an auxiliary light guide plate, and a reflection sheet according to another embodiment.

### DESCRIPTION OF EMBODIMENTS

### First Embodiment

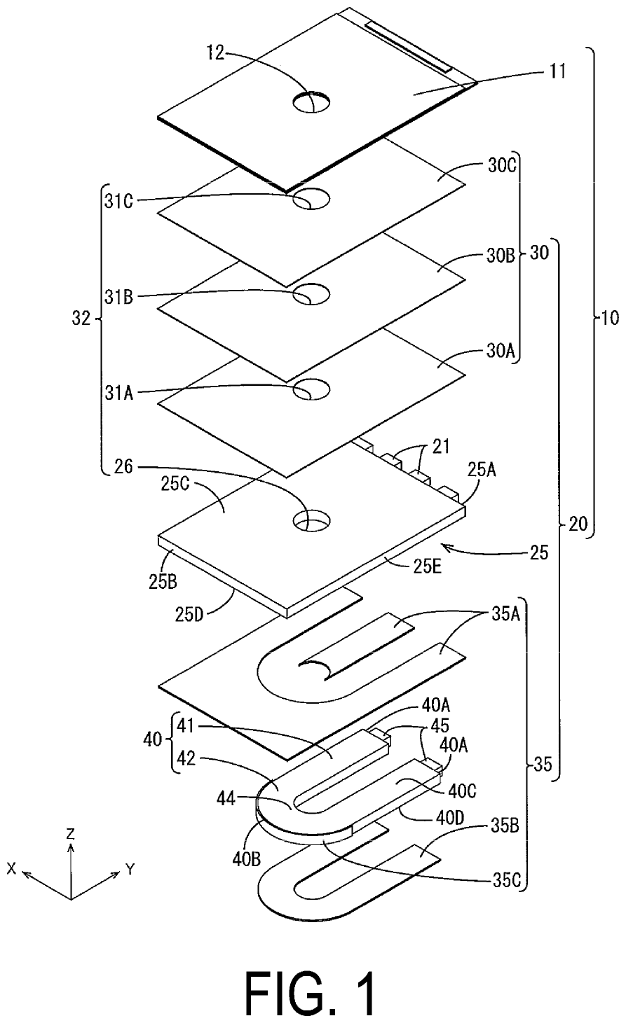

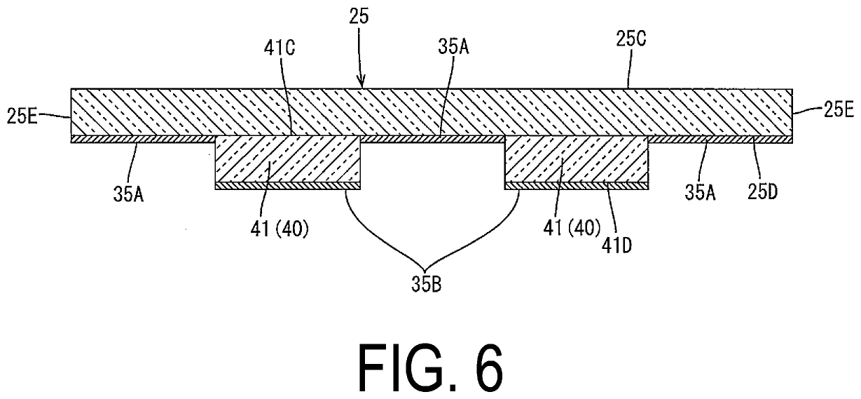

The first embodiment will be described with reference to FIGS. 1 to 6. In the present embodiment, a liquid crystal display device 10 (one example of a display device) including a liquid crystal panel 11 (one example of a display panel) capable of displaying an image and a backlight device 20 (one example of an illumination device) supplying light for display to the liquid crystal panel 11 is illustrated. Note that an X-axis, a Y-axis, and a Z-axis are illustrated in a part of each drawing, and illustration is made so that the respective directions correspond to directions illustrated in each drawing. A vertical direction is based on a vertical direction in FIG. 1, an upper side in FIG. 1 is referred to as a front side, and a lower side of FIG. 1 is referred to as a rear side. An X-axis direction is a width direction or a lateral direction, a Y-axis direction is a length direction, and a Z-axis direction is a thickness direction.

The liquid crystal display device 10 according to the present embodiment is generally rectangular in a planar view and formed into substantially a block shape, in which the liquid crystal panel 11 and the backlight device 20 disposed on the rear side of the liquid crystal panel 11 are integrally formed with each other via a double-sided tape or the like. The liquid crystal display device 10 according to the present embodiment is, for example, mounted on a dashboard of an automobile for use, configures a part of an instrument panel, and can display a part of an instrument of an instrument panel, various warning images, a map image of a car navigation system, an image captured by an onboard camera, and the like.

The liquid crystal panel 11 has a rectangular plate shape, and although a detailed illustration thereof is omitted, the liquid crystal panel 11 has a well-known configuration in which a pair of transparent glass substrates (having high translucency) are adhered to each other with a predetermined gap interposed therebetween, and a liquid crystal layer is disposed between both glass substrates. One glass substrate is provided with a switching element (for example, TFT) connected to a source wiring line and a gate wiring line that are orthogonal to each other, a pixel electrode connected to the switching element, and further, an alignment film or the like, and the other glass substrate is provided with a color filter in which colored parts of R (red), G (green), and B (blue) are arranged in a predetermined arrangement, a counter electrode, an alignment film, or the like. Among these, image data and various control signals necessary to display images from a drive circuit substrate are supplied to the source wiring line, the gate wiring line, the counter electrode, and the like. A polarizer is disposed on an outer side of both glass substrates.

The liquid crystal panel 11 can display an image by using light supplied from the backlight device 20, and a front side thereof is a light exit side. Note that a short side direction of the liquid crystal panel 11 coincides with the X-axis direction, a long side direction coincides with the Y-axis direction, and the thickness direction coincides with the Z-axis direction.

A panel through-hole 12 (one example of a panel cutout portion) passes through the liquid crystal panel 11 according to the present embodiment. The panel through-hole 12 is in mutual communication with a device through-hole 32 of the backlight device 20 described below, and is for passing an object such as a needle of a mechanical instrument provided in the instrument panel disposed on the rear side of the liquid crystal display device 10. A hole edge portion of the panel through-hole 12 is sealed by a sealing member so that liquid crystals do not leak out.

The backlight device 20, like the liquid crystal panel 11, is generally rectangular in a planar view and formed into substantially a block shape. The backlight device 20 includes at least a plurality of LEDs 21 (Light Emitting Diode) as light sources and a LED substrate having the LEDs 21 provided thereon, a light guide plate 25 that guides light emitted from the LED 21, a plurality of optical sheets 30 layered on a front side of the light guide plate 25, and a reflection sheet 35 disposed on a rear side of the light guide plate 25.

The backlight device 20 is a one-side light incident edge light type (side light type) in which the LEDs 21 are disposed on the end face of one short side of the light guide plate 25 such that the light is incident on the light guide plate 25 from only one side. The backlight device 20 is configured to convert lights from the LEDs 21 into planar lights to emit toward the liquid crystal panel 11 on the front side. In other words, the backlight device 20 has a front side as a light exit side. Components of the backlight device 20 will be described below.

The LED 21 has a configuration in which a LED chip (LED element) that is a semiconductor light emitting element is sealed, with a resin material, on a substrate portion fixed to a plate surface of the LED substrate, which will be described later. The LED chip mounted on the substrate portion used here has one kind of main light emission wavelength, and specifically, emits one color light of blue light. On the other hand, the resin material sealing the LED chip contains a phosphor dispersed therein that is excited by the blue light emitted from the LED chip to emit the light of a predetermined color, and generally emits white light. This LED 21 is a so-called side light emitting type in which a side surface thereof adjacent to the mounting surface of the LED substrate is a light-emitting face.

The LED 21 emits light having a predetermined spread (directionality) centered on an optical axis L from the light-emitting face. In the case of the present embodiment, the light axis L of the emitted light is substantially perpendicular to the central portion of the light-emitting face and coincides with the Y-axis direction. Therefore, among the lights from LED 21, light traveling toward the end face (counter light incident surface 25B and a pair of side surfaces 25E) other than the light incident surface 25A of the light guide plate 25 described below is larger in amount on the counter light incident surface 25B than the pair of side surfaces 25E.

The LED substrate has a configuration in which a plurality of LEDs 21 are mounted and arranged at intervals on surface of a film-like (sheet-like) base material that is made of an insulating material and has flexibility, and a wiring pattern for supplying power to the LEDs 21 is patterned. The LED substrate is disposed such that the light-emitting faces of the mounted LEDs 21 face the light incident surface 25A of the light guide plate 25 in parallel.

Next, the light guide plate 25 will be described. The light guide plate 25 may be formed from a material having a sufficiently higher refractive index than air and excellent translucency, for example, a resin such as transparent acrylic or polycarbonate, or a variety of glass. The light guide plate 25 according to the present embodiment is formed from an acrylic resin and, as illustrated in FIG. 1, has a rectangular plate shape. The light guide plate 25 has a short side direction, a long side direction, and a thickness direction corresponding to the X-axis direction, the Y-axis direction, and the Z-axis direction, respectively.

An end face of outer peripheral end faces of the light guide plate 25 on the short side on the right back side thereof illustrated in FIG. 1 is a light incident surface 25A that faces the light-emitting face of LED 21 in parallel and on which light from LED 21 is incident. In the present embodiment, an end face opposite to the light incident surface 25A (an end face on a left front side in FIG. 1) is a counter light incident surface 25B, an upper face (front surface) of the pair of plate surfaces is a light exit surface 25C that outputs light toward the liquid crystal panel 11, and a lower face (rear face) of the pair of plate surfaces is referred to as a counter light exit surface 25D. Furthermore, end faces of the outer peripheral end faces of the light guide plate 25 on the long side thereof (the end faces other than the light incident surface 25A and the counter light incident surface 25B) are referred to as a pair of side surfaces 25E.

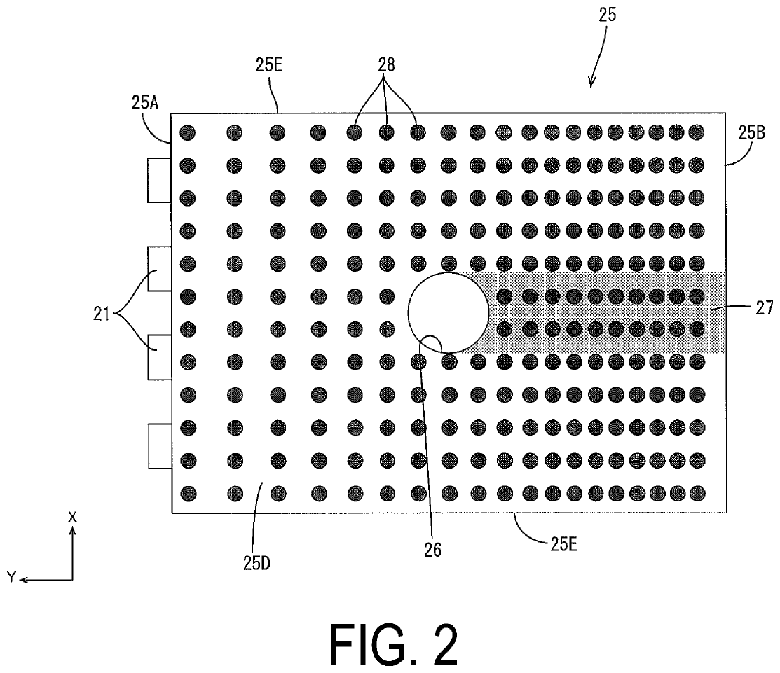

As illustrated in FIG. 2, an uneven pattern having a plurality of lenticular protrusions 28 protruding toward the rear side is provided on the counter light exit surface 25D of the light guide plate 25. The sparser the uneven pattern is, the closer to the light incident surface 25A side (the left side in FIG. 2), and the denser gradually, the closer to the opposite side (the counter light incident surface 25B side). According to such a configuration, each light guide plate 25 has a function of introducing light from the light incident surface 25A and raising the light up along the Z-axis direction by the uneven pattern while propagating the light therein, and outputting the light from the light exit surface 25C toward the front side (liquid crystal panel 11 side).

The light guide plate 25 is disposed right under the liquid crystal panel 11 with the optical sheet 30 interposed therebetween, and is provided with a light guide plate through-hole 26 (an example of the cutout portion) at a position corresponding to the panel through-hole 12 described above, in a state in which the liquid crystal panel 11 and the light guide plate 25 are assembled at correct positions. Specifically, as illustrated in FIG. 2, the light guide plate through-hole 26 is provided in the center portion in the width direction (X-axis direction) and the length direction (Y-axis direction) of the light guide plate 25.

As illustrated in FIG. 1, three layers of the optical sheet 30 are stacked on the light exit surface 25C of the light guide plate 25. The optical sheet 30 has a flat rectangular sheet shape, and a short side direction and long side direction thereof coincide with the X-axis direction and the Y-axis direction, respectively. The optical sheet 30 is disposed to be interposed between the light guide plate 25 and the liquid crystal panel 11 so as to transmit the emission light from the light guide plate 25 and deliver the transmitted light to the liquid crystal panel 11 while imparting a predetermined optical effect to the transmitted light.

The optical sheet 30 according to the present embodiment includes a diffuser sheet 30A, a lens sheet 30B, and a reflective polarizing sheet 30C which are layered in order from a lower layer side. The sheets 30A, 30B, and 30C are provided with sheet through-holes 31A, 31B, and 31C, respectively, at positions corresponding to the light guide plate through-hole 26. Hereinafter, a through-hole formed by these sheet through-holes 31A, 31B, and 31C, and the light guide plate through-hole 26 is referred to as a device through-hole 32.

Here, in the edge light type backlight device 20, in the configuration as described above in which the light guide plate through-hole 26 that penetrates the plate surface is provided in the light guide plate 25, a portion of light having directionality incident on the light guide plate 25 from the light incident surface 25A is blocked on an optical path thereof by an object not illustrated in the drawings that is inserted through the light guide plate through-hole 26 or the light guide plate through-hole 26 itself. Therefore, a region of the light guide plate 25 closer to the counter light incident surface 25B than the light guide plate through-hole 26, that is, a region between the light guide plate through-hole 26 and the counter light incident surface 25B, is an obscured portion 27 which is not easily reached by light (see FIG. 2). More specifically, the obscured portion 27 includes a region which is hardly reached by light that is slight adjacent to the light guide plate through-hole 26, and a region that is slightly away from the light guide plate through-hole 26, illuminated a little although with low brightness, which is not reached by light that travels straight along the optical axis (Y-axis), but is reached by light that travels straight in an oblique direction without along the optical axis or by a portion of light reflected by the side surface 25E. The obscured portion 27 generates a brightness unevenness in the backlight device 20.

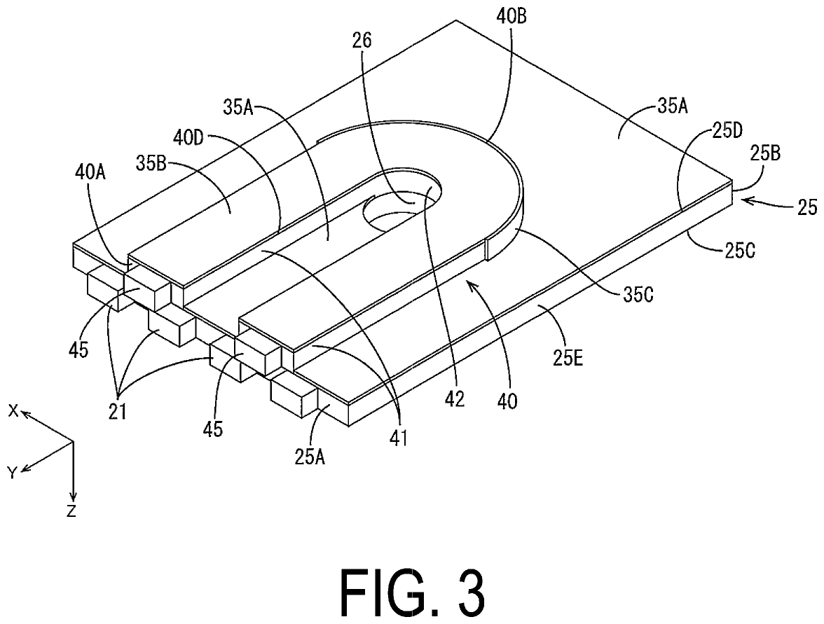

To address such a problem, the backlight device 20 according to the present embodiment includes an auxiliary light guide plate 40 having an external shape different from the light guide plate 25. The auxiliary light guide plate 40 is made of an acrylic resin similarly to the light guide plate 25, and is generally formed into a U-shape, is entirely overlaid on the lower face of the light guide plate 25 (the counter light exit surface 25D, the surface opposite to the liquid crystal panel 11), and is integrally formed with the light guide plate 25, for example, by a light-transmissive adhesive or the like, as illustrated in FIGS. 3 to 5, for example.

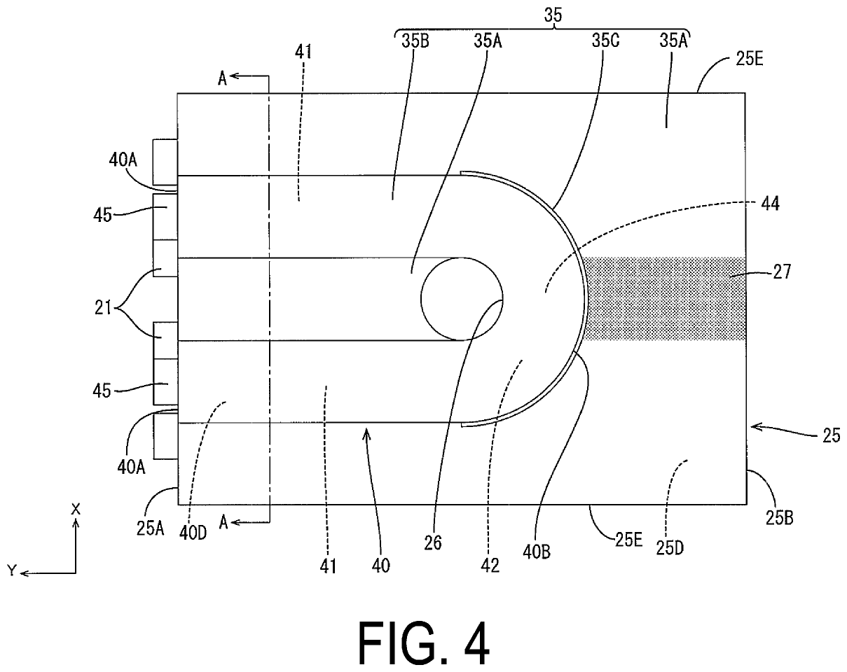

Specifically, the auxiliary light guide plate 40 is formed into a U-shape including a pair of parallel linear portions 41 and a curved portion (one example of a bent portion) 42, the pair of linear portions 41 being disposed to extend linearly from the light incident surface 25A of the light guide plate 25 to the counter light incident surface 25B side when the light guide plate 25 is seen in a plan view to sandwich the light guide plate through-hole 26 from the lateral sides (in the width direction), the curved portion 42 being curved in a semi-circular shape to wrap around the light guide plate through-hole 26 from the lateral sides of the light guide plate through-hole 26 from the obscured portion 27 side to connect the pair of linear portions 41. An inner peripheral edge of the curved portion 42 is configured to coincide with a hole edge portion of the light guide plate through-hole 26. With such a configuration, a portion of the curved portion 42 of the auxiliary light guide plate 40 (a center portion) is in a state of being overlaid on a region of the obscured portion 27 adjacent to the light guide plate through-hole 26 (see FIG. 4).

Among outer peripheral end faces of the auxiliary light guide plate 40 formed into a U-shape, an end face being overlaid on the light incident surface 25A of the light guide plate 25 described above is an auxiliary light guide plate-side light incident surface 40A, and an auxiliary LED 45 that emits light toward the auxiliary light guide plate 40 is disposed to face the auxiliary light guide plate-side light incident surface 40A. In other words, the light incident surfaces 25A and 40A of the light guide plate 25 and the auxiliary light guide plate 40, respectively, are overlaid with each other to face the same direction, and the LED 21 and the auxiliary LED 45 can be collectively disposed in a state of being overlaid with each other on one side of the light guide plate 25 and the auxiliary light guide plate 40.

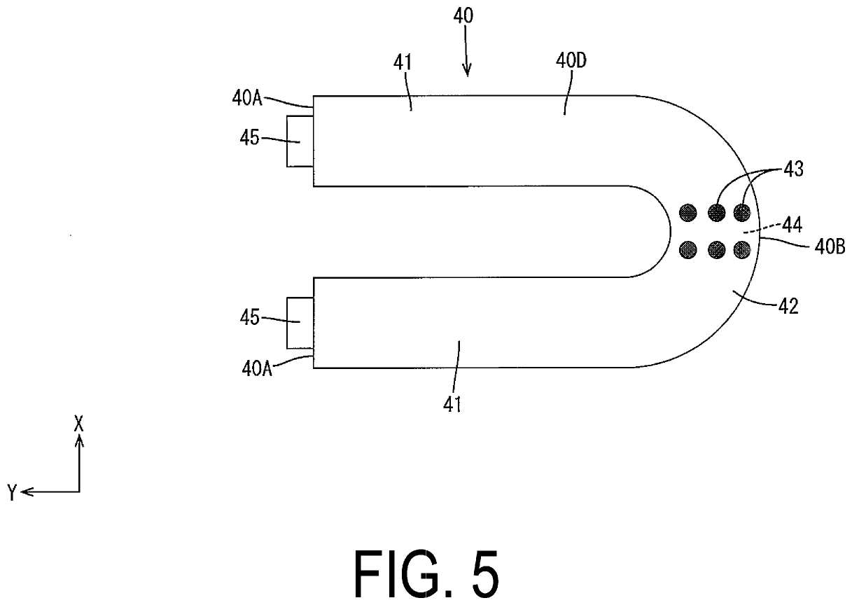

Furthermore, a region, in a lower face of the auxiliary light guide plate 40 (referred to as an auxiliary light guide plate-side counter light exit surface 40D) of the auxiliary light guide plate 40, that overlaps the obscured portion 27 in a state in which the auxiliary light guide plate 40 is overlaid on the light guide plate 25 is provided with an uneven pattern having a plurality of lenticular protrusions 43 protruding toward the rear side (see FIG. 5). With such a configuration, the auxiliary light guide plate 40 introduces light from the auxiliary LED 45 through the auxiliary light guide plate-side light incident surface 40A and propagates the light therein, and thereafter, raises the light by the uneven pattern (lenticular protrusion 43) of the curved portion 42 up along the Z-axis direction to output the light toward the front side (the liquid crystal panel 11 side, that is, the auxiliary light guide plate-side light exit surface 40C). Hereinafter, the region of the auxiliary light guide plate 40 where light is output by the uneven pattern is referred to as a light exit section 44. Note that, a region of the auxiliary light guide plate 40 other than the region overlapping the obscured portion 27 is not provided with the uneven pattern. In FIGS. 3, 4, and 6, the uneven pattern (lenticular protrusion 43) is omitted.

The backlight device 20 according to the present embodiment includes the reflection sheet 35. The reflection sheet 35 is disposed on the rear face of the entire light guide plate including the light guide plate 25 and the auxiliary light guide plate 40. Specifically, the reflection sheet 35 includes, in the counter light exit surface 25D of the light guide plate 25, at least a first reflecting portion 35A layered on a region other than a region overlaid by the auxiliary light guide plate 40, and a second reflecting portion 35B layered on the entire auxiliary light guide plate-side counter light exit surface 40D of the auxiliary light guide plate 40. The reflection sheet 35 also includes a third reflecting portion 35C laminated along an end face on the outer peripheral side of the curved portion 42 of the auxiliary light guide plate 40 (referred to as a light guide plate-side counter light incident surface 40B). It is effective to provide the reflection sheet 35 (third reflecting portion 35C) on the outer peripheral surface (light guide plate-side counter light incident surface 40B) of the curved portion 42 where an incident angle of light is smaller than the other side surfaces of the auxiliary light guide plate 40 and total reflection hardly occurs. In the present embodiment, these reflecting portions 35A, 35B, and 35C are separated, and each reflecting portion is attached to the light guide plate 25 and the auxiliary light guide plate 40 (see FIG. 3).

Note that the reflection sheet 35 is made of a synthetic resin material with at least a reflective surface having excellent light reflectivity, and is capable of efficiently reflecting light that propagates through the light guide plate 25 and escapes from the counter light exit surface 25D, the auxiliary light guide plate-side counter light exit surface 40D, and the light guide plate-side counter light incident surface 40B toward to light guide plate 25 or the auxiliary light guide plate 40.

The LED substrate, the light guide plate 25, the auxiliary light guide plate 40, the optical sheet 30, the reflection sheet 35, and the like described above are integrated with the liquid crystal panel 11 by, for example, a fixing member such as a double-sided tape and a light-transmissive adhesive to form the liquid crystal display device 10.

The liquid crystal display device 10 according to the present embodiment is configured as described above, and next, the effect will be described.

The backlight device 20 according to the present embodiment includes the LED 21 and the light guide plate 25 configured to guide light from the LED 21, wherein the light guide plate 25 includes a light incident surface 25A on which the light from the LED 21 is incident, a counter light incident surface 25B opposite to the light incident surface 25A, a light exit surface 25C that is one of a pair of plate surfaces and outputs the light, and a counter light exit surface 25D opposite to the light exit surface 25C, and is provided with the light guide plate through-hole 26 (one example of the cutout portion), at least one of the pair of plate surfaces of the light guide plate 25 is provided with the auxiliary light guide plate 40, the auxiliary light guide plate 40 being configured with a plate-shaped member extending from the light incident surface 25A to the obscured portion 27 (a region between the light guide plate through-hole 26 and the counter light incident surface 25B), the auxiliary light guide plate-side light incident surface 40A, among the end faces of the auxiliary light guide plate 40, disposed on the light incident surface 25A side is provided with the auxiliary LED 45, the auxiliary LED 45 being configured to emit light toward the auxiliary light guide plate-side light incident surface 40A, and a region, of the auxiliary light guide plate 40, overlapping the obscured portion 27 of the light guide plate 25 is the light exit section 44, the light exit section 44 being configured to output light from the auxiliary LED 45 toward the obscured portion 27.

According to such a configuration, even when light that is incident on the light incident surface 25A of the light guide plate 25 and guided inside the light guide plate 25 is blocked on an optical path thereof by the light guide plate through-hole 26, the obscured portion 27 is selectively illuminated by locally outputting, from the light exit section 44, light that is independently guided by the auxiliary light guide plate 40. Thus, the brightness of the obscured portion 27 is improved, and the brightness unevenness of the backlight device 20 and the liquid crystal display device 10 can be suppressed.

Further, in the backlight device 20 according to the present embodiment, the auxiliary light guide plate 40 is disposed to overlap the counter light exit surface 25D of the light guide plate 25.

According to such a configuration, the light locally output from the light exit section 44 of the auxiliary light guide plate 40 passes through the light guide plate 25 and is output from the light exit surface 25C of the light guide plate 25. As a result, compared to a configuration in which the auxiliary light guide plate 40 is disposed to overlap the light exit surface 25C side of the light guide plate 25, a boundary between the light guide plate 25 and the auxiliary light guide plate 40 is difficult to distinguish when viewed from the light exit surface 25C side, and more uniform light is output, and therefore, the brightness unevenness can be further suppressed.

The light incident surface 25A of the light guide plate 25 and the auxiliary light guide plate-side light incident surface 40A of the auxiliary light guide plate 40 are disposed to be overlapped with each other. According to such a configuration, the LED 21 and the auxiliary LED 45 can be collectively disposed in a state of being overlaid with each other on one side of the light guide plate 25 and the auxiliary light guide plate 40, and thus, a simple configuration can be achieved.

The auxiliary light guide plate 40 is disposed to entirely overlap the light guide plate 25. According to such a configuration, the auxiliary light guide plate 40 does not protrude in a plate surface direction from the light guide plate 25, and thus a cutout portion such as the light guide plate through-hole 26 provided in the light guide plate 25 can be utilized.

The light guide plate 25 is provided with the light guide plate through-hole 26, the auxiliary light guide plate 40 is formed into a U-shape including the pair of linear portions 41 and the curved portion 42, the pair of linear portions 41 being disposed to extend linearly from the light incident surface 25A to lateral side portions of the light guide plate through-hole 26, the curved portion 42 being curved to wrap around the light guide plate through-hole 26 inward continuously from the linear portions 41. According to such a configuration, the obscured portion 27 can be efficiently radiated with the light from the auxiliary LED 45 by the auxiliary light guide plate 40.

The reflection sheet 35 (third reflecting portion 35C) that reflects light is provided on the light guide plate-side counter light incident surface 40B that is the outer peripheral end face of the curved portion 42. According to such a configuration, light escaping from the curved portion 42 where an incident angle of light is smaller than the other side surfaces of the auxiliary light guide plate 40 and total reflection hardly occurs can be efficiently returned to the auxiliary light guide plate 40.

The liquid crystal display device 10 according to the present embodiment includes the liquid crystal panel 11 and the backlight device 20 described above. The liquid crystal panel 11 includes the panel through-hole 12 that penetrates the plate surface at a position corresponding to the light guide plate through-hole 26.

According to the liquid crystal display device 10 and the backlight device 20 described above according to the present embodiment, the brightness unevenness can be suppressed even in a case that the through-holes 12 and 26 are provided in the liquid crystal panel 11 and the light guide plate 25.

### Second Embodiment

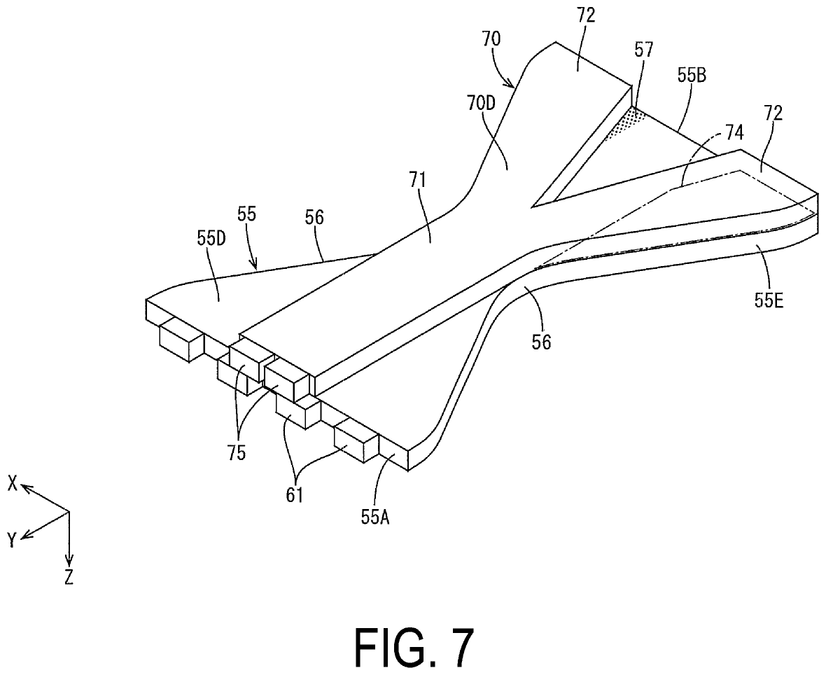

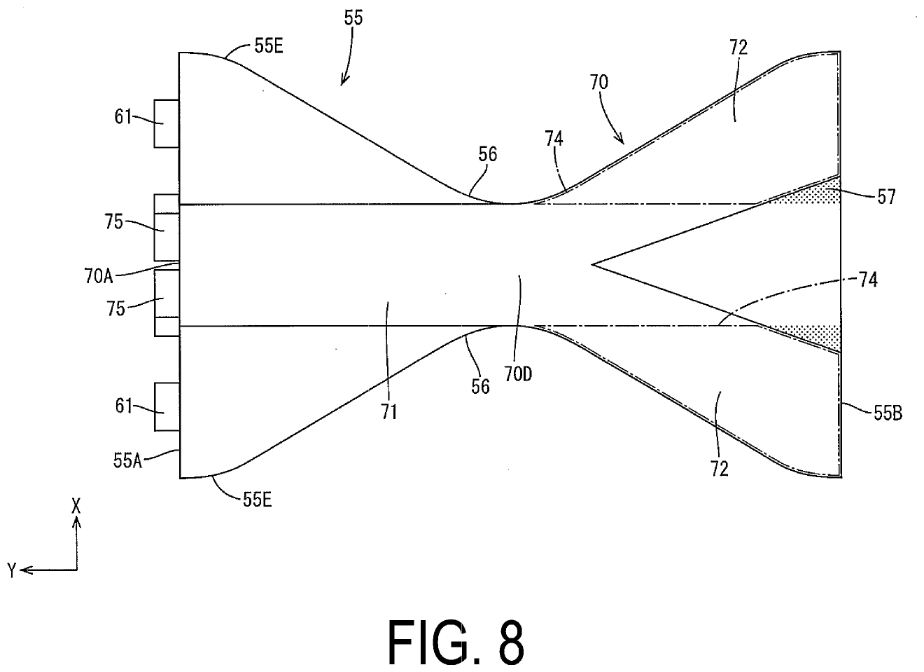

Next, the second embodiment will be described with reference to FIGS. 7 and 8. A liquid crystal display device and a backlight device according to the present embodiment differ from the first embodiment described above in a position and shape of a cutout portion provided in a light guide plate 55. Hereinafter, a configuration different from the first embodiment will be described, and similar configurations are assigned with reference signs obtained by adding 30 to the reference signs in the first embodiment and descriptions thereof will be omitted.

The light guide plate 55 used in the present embodiment differs from the first embodiment in that, instead of the light guide plate through-hole 26 of the first embodiment, a narrowed portion 56 (one example of the cutout portion and the recessed portion) is provided that is formed by cutting out substantially entirely each of end edge portions on long sides of the light guide plate 55 constituting a pair of side surface 55E into a flattened U-shape. The pair of narrowed portions 56 are axisymmetric with respect to a long side direction (Y-axis direction) of the light guide plate 55.

According to such a configuration, a portion of the light having directionality incident on the light guide plate 55 from a light incident surface 55A is blocked on an optical path thereof by a member disposed in the narrowed portion 56 or the narrowed portion 56 itself. Thus, a region between the narrowed portions 56 and a counter light incident surface 55B is an obscured portion 57 where is not easily reached by light. The obscured portion 57 generates a brightness unevenness in the backlight device.

Therefore, the light guide plate 55 according to the present embodiment is integrally provided with an auxiliary light guide plate 70 extending from the light incident surface 55A to the obscured portion 57 similarly to the above-described embodiment. The auxiliary light guide plate 70 according to the present embodiment is generally formed into a Y-shape, and includes a linear portion 71 and a pair of branch portions 72, the linear portion 71 extending from the center of the light incident surface 55A of the light guide plate 55 in the width direction (X-axis direction) toward the counter light incident surface 55B, the pair of branch portions 72 extending along the edge portions of the pair of narrowed portions 56 on the counter light incident surface 55B side. The outer peripheral edge of each branch portion 72 is configured to coincide with a side edge on the counter light incident surface 55B side of the narrowed portion 56. With such a configuration, a portion of each branch portion 72 of the auxiliary light guide plate 70 is in a state of being overlaid on a region of the obscured portion 57 adjacent to the narrowed portion 56.

Among end faces of the auxiliary light guide plate 70 formed into a Y-shape, an end face overlaid with the light incident surface 55A of the light guide plate 55 is an auxiliary light guide plate-side light incident surface 70A, and an auxiliary LED 75 that emits light toward the auxiliary light guide plate 70 is disposed to face the auxiliary light guide plate-side light incident surface 70A. In other words, the light incident surfaces 55A and 70A of the light guide plate 55 and the auxiliary light guide plate 70, respectively, are overlaid with each other to face the same direction, and the LED 61 and the auxiliary LED 75 can be collectively disposed in a state of being overlaid with each other on one side of the light guide plate 55 and the auxiliary light guide plate 70.

Furthermore, a region, in a lower face of the auxiliary light guide plate 70 (referred to as an auxiliary light guide plate-side counter light exit surface 70D) of the auxiliary light guide plate 70, that overlaps the obscured portion 57 in a state in which the auxiliary light guide plate 70 is overlaid on the light guide plate 55 is a light exit section 74 provided with an uneven pattern having a plurality of lenticular protrusions protruding toward the rear side. With such a configuration, the auxiliary light guide plate 70 introduces light from the auxiliary LED 75 through the auxiliary light guide plate-side light incident surface 70A and propagates the light therein, and thereafter, raises the light by the light exit section 74 up along the Z-axis direction to output the light toward the front side (the liquid crystal panel 11 side).

Note that in the present embodiment as well, similar to the embodiment described above, the reflective sheet is disposed on the entire rear face of the light guide plate 55 including the auxiliary light guide plate 70.

According to the embodiment like this as well, similar to the first embodiment described above, even in a case that light that is incident on the light incident surface 55A of the light guide plate 55 and guided inside the light guide plate 55 is blocked on an optical path thereof by the narrowed portions 56, the obscured portion 57 is illuminated by light selectively output from the light exit section 74 of the auxiliary light guide plate 70, and therefore, the brightness unevenness can be suppressed.

### Other Embodiments

The technique disclosed herein is not limited to the embodiments described above and illustrated by the drawings, and embodiments such as those described below are also included within the technical scope of the present disclosure.

(1) In the embodiments described above, the example has been given of a planar liquid crystal display device including the light guide plate through-hole 26 and the narrowed portion 56. However, the technique disclosed herein can also be applied to a display device having a curved surface shape, a display device provided with two or more through-holes, or a display device having a shape different from those described above.

(2) The form of the auxiliary light guide plates 40 and 70 are not limited to the embodiments described above. In other words, the auxiliary light guide plate 40 or 70 may have any form as long as the auxiliary light guide plate 40 or 70 is provided with the light exit section 44 or 74 that outputs light to at least a portion of the obscured portion 27 or 57.

(3) In the embodiment described above, the configuration is illustrated in which the auxiliary light guide plates 40 and 70 are overlaid on portions of the obscured portions 27 and 57, respectively, but the auxiliary light guide plates 40 and 70 may be configured to be overlaid on the entire obscured portions. In this case, it is possible to adjust the intensity of the emission light by changing the uneven pattern in accordance with the brightness of the region in the obscured portion.

(4) The auxiliary light guide plate may not be entirely overlaid on the light guide plate. That is, a configuration that the auxiliary light guide plate is disposed to protrude from the light guide plate is included in the technical scope disclosed herein.

(5) In the embodiments described above, the LEDs 21 and 61 of the light guide plates 25 and 55, and the auxiliary LEDs 45 and 75 of the auxiliary light guide plates 40 and 70 are provided separately. However, the LED and the auxiliary LED may be the same. That is, a large LED that spans the light incident surfaces of both the light guide plate and the auxiliary light guide plate may be used at the position where the auxiliary light guide plate is disposed.

(6) In the embodiments described above, the configuration is illustrated in which the auxiliary light guide plates 40 and 70 are overlaid on the counter light exit surfaces 25D and 55D of the light guide plates 25 and 55. However, the auxiliary light guide plate may be configured to be overlaid on the light exit surface. The auxiliary light guide plate may also be overlaid on both surfaces.

(7) The light incident surface of the light guide plate and the light incident surface of the auxiliary light guide plate need not necessarily be disposed to be overlapped with each other.

(8) An emission pattern of the light exit section is not limited to a lenticular protrusion. For example, the pattern may have a rough surface or a prismatic shape, or in other words, may have a shape having a function of outputting light toward the obscured portion.

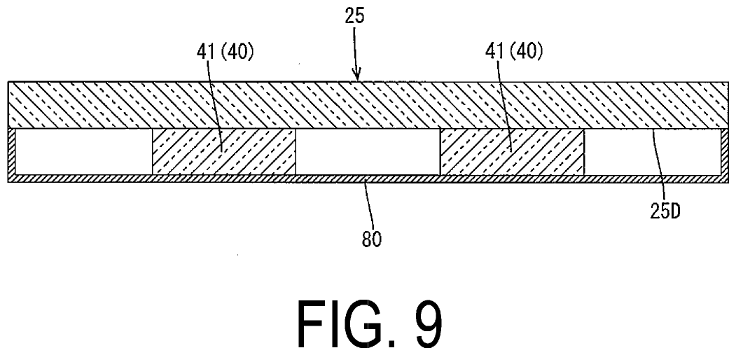

(9) In the embodiments described above, the configuration is illustrated in which the reflection sheet 35 is divided and applied to the light guide plate 25 (excluding the region where the auxiliary light guide plate is disposed) and the rear face of the auxiliary light guide plate 40 (counter light exit surfaces 25D, 40D). However, as illustrated in FIG. 9, a reflection sheet 80 may be configured to cover the entire light guide plate 25 and the auxiliary light guide plate 40 with a single sheet. In this case, the counter light exit surface 25D and the reflection sheet 80 may be disposed in a separated state.

(10) In the first embodiment described above, the auxiliary light guide plate 40 is constituted with the pair of linear portions 41 and the curved portion 42. However, the curved portion may be a bending portion in a shape obtained by bending a straight line.

1. An illumination device comprising:
a light source; and
a light guide plate configured to guide light from the light source,
wherein the light guide plate includes a light incident surface on which the light from the light source is incident, a counter light incident surface opposite to the light incident surface, a light exit surface that is one of a pair of plate surfaces and outputs the light, and a counter light exit surface opposite to the light exit surface, and is provided with a cutout portion with a portion partially cut out,
at least one of the pair of plate surfaces of the light guide plate is provided with an auxiliary light guide plate, the auxiliary light guide plate being configured with a plate-shaped member extending from the light incident surface to a region between the cutout portion and the counter light incident surface,
an auxiliary light guide plate-side light incident surface, among end faces of the auxiliary light guide plate, disposed on the light incident surface side is provided with an auxiliary light source, the auxiliary light source being configured to emit light toward the auxiliary light guide plate-side light incident surface, and
a region, of the auxiliary light guide plate, overlapping the region of the light guide plate between the cutout portion and the counter light incident surface is a light exit section, the light exit section being configured to output light from the auxiliary light source toward the region of the light guide plate between the cutout portion and the counter light incident surface.

2. The illumination device according to claim 1,
wherein the auxiliary light guide plate is disposed to overlap the counter light exit surface of the light guide plate.

3. The illumination device according to claim 1,
wherein the light incident surface of the light guide plate and the auxiliary light guide plate-side light incident surface of the auxiliary light guide plate are disposed to be overlapped with each other.

4. The illumination device according to claim 1,
wherein the auxiliary light guide plate is disposed to entirely overlap the light guide plate.

5. The illumination device according to claim 1,
wherein the cutout portion is a through-hole penetrating the light guide plate.

6. The illumination device according to claim 5,
wherein the auxiliary light guide plate is formed into a U-shape including a pair of linear portions and a bent portion, the pair of linear portions extending from the light incident surface to a lateral side portions of the through-hole, and the bent portion being curved or bent to wrap around inward the through-hole continuously from the linear portions.

7. The illumination device according to claim 6,
wherein a reflection sheet that reflects light is provided on an end face on an outer peripheral side of the bent portion.

8. The illumination device according to claim 1,
wherein the cutout portion is a recessed portion recessed concavely from a side edge of the light guide plate.

9. A display device comprising:
the illumination device according to claim 1; and
a display panel configured to perform display by using light from the illumination device.

10. The display device according to claim 9,
wherein the display panel includes a panel cutout portion cut out along the cutout portion at a position corresponding to the cutout portion.
